(19) United States
(12) Patent Application Publication
(10) Pub. No.: US 2015/0242857 A1
(43) Pub. Date: Aug. 27, 2015

(54) Transaction Risk Assessment Aggregation

(71) Applicant: Bank of America Corporation, Charlotte, NC (US)

(72) Inventors: Richard E. Wilcox, Charlotte, NC (US); Eugene M. Davis, Fort Mill, SC (US); Mackenzie M. Smith, Charlotte, NC (US); Kevin M. Woerner, Concord, NC (US); Roberta S. Sperry, Charlotte, NC (US)

(73) Assignee: Bank of America Corporation, Charlotte, NC (US)

(21) Appl. No.: 14/187,637

(22) Filed: Feb. 24, 2014

(51) Int. Cl. G06Q 20/40

(52) U.S. Cl. CPC G06Q 20/4016

(57) ABSTRACT

Aggregating risk assessments associated with a vendor may comprise retrieving a transaction risk assessment for a first transaction. A transaction risk assessment for a second transaction is retrieved. A first response to a question for measuring risk to an entity is determined. The first response is associated with the first transaction and indicative of risk associated with engaging a vendor to supply a first product to the entity. A second response to the question for measuring risk to the entity is determined. The second response is associated with the second transaction and indicative of risk associated with engaging the vendor to supply a second product to the entity. The first response is aggregated with the second response to determine an aggregated response to the question according to a highest level of risk perceived by the vendor from outsourcing the first product and the second product to the vendor.

### TECHNICAL FIELD OF THE INVENTION

This invention relates, in general, to transaction risk assessment and, more particularly, to aggregation of transaction risk assessments.

### BACKGROUND OF THE INVENTION

Entities receive products from a variety of vendors. Some vendors have access to sensitive information of the organization. Additionally, certain vendors are subject to various governmental regulations and/or industry standards. Moreover, some vendors have news or media attention that, subsequently, may become associated with the entity. Because of these various issues, entities may take on varying amounts of risk by receiving products from certain vendors.

### SUMMARY OF THE INVENTION

In accordance with the present invention, disadvantages and problems associated with transaction risk assessment aggregation may be reduced or eliminated.

According to one embodiment of the present invention, a method for aggregating risk assessments associated with a vendor comprises retrieving a transaction risk assessment for a first transaction. A transaction risk assessment for a second transaction is retrieved. A first response to a question for measuring risk to an entity is determined. The first response is associated with the first transaction and indicative of risk associated with engaging a vendor to supply a first product to the entity. A second response to the question for measuring risk to the entity is determined. The second response is associated with the second transaction and indicative of risk associated with engaging the vendor to supply a second product to the entity. The first response from the first transaction is compared to the second response from the second transaction. The first response is aggregated with the second response to determine an aggregated response to the question according to a highest level of risk perceived by the vendor from outsourcing the first product and the second product from the vendor.

Certain embodiments of the invention may provide one or more technical advantages. A technical advantage of one embodiment allows for automatic aggregation of transaction risk assessments. Another technical advantage of an embodiment allows for automation and optimization of one or more steps in a vendor management process, reducing the overall manual workload of an assigned vendor manager. With automated aggregation processes, a vendor manager's workload may be limited to validation of an aggregation. Another technical advantage of an embodiment allows for identification of risk by automated processes at the risk element level. Management actions may be identified automatically and tailored specifically to the risk element identified rather than and/or in addition to management actions identified based on overall risk levels.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system operable to manage activities associated with the supplying products from a vendor to an entity.

FIGS. 2A and 2B illustrate an example method for managing activities associated with supplying products from one or more vendors to an entity.

FIG. 3 illustrates an example method for determining the conditions under which a risk element may be identified together with any suitable management actions for reducing the risk associated with the identified risk element.

FIG. 4 illustrates an example method for to determining risks inherent with outsourcing a product based on the product's category.

FIG. 5 illustrates an example method for determining risks inherent with outsourcing a product to a particular vendor in the context of a particular transaction.

FIG. 6 illustrates an example method for aggregating the results of completed individual transaction risk assessments for a vendor.

FIG. 7 illustrates an example method for creating a vendor profile comprising information related to risk and performance of a particular vendor that supplies one or more products to an entity.

FIG. 8 illustrates an example method for stratifying where in a vendor management process a vendor manager needs to be assigned.

FIG. 9 illustrates an example method for executing a distributed control function for overseeing execution of the vendor management process within an entity.

### DETAILED DESCRIPTION OF EXAMPLE EMBODIMENTS

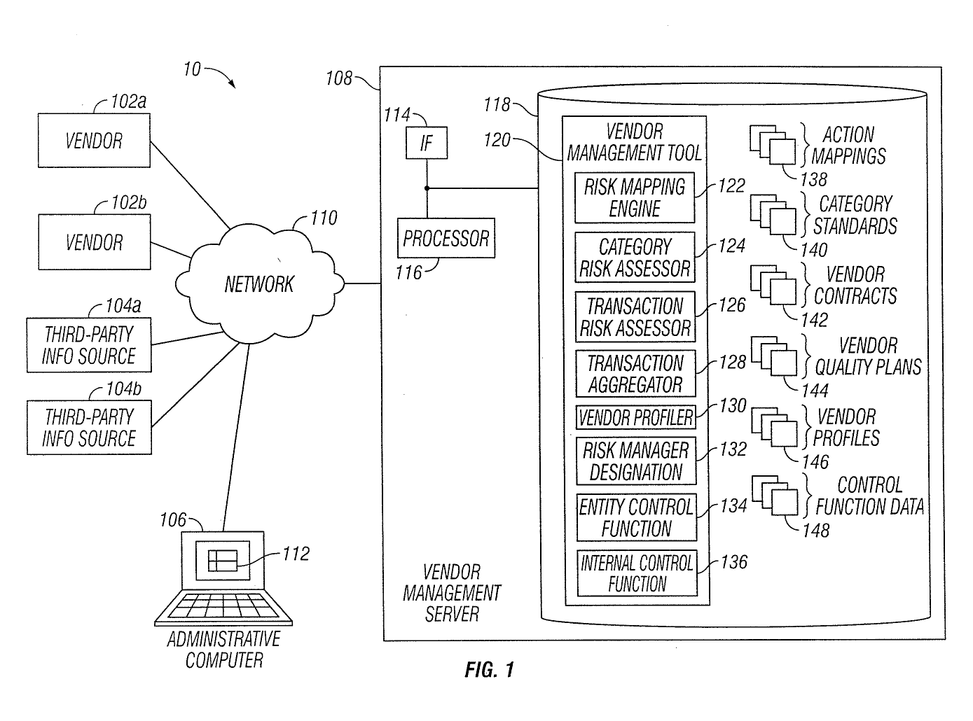

Embodiments of the present invention and its advantages are best understood by referring to FIGS. 1 through 9, like numerals being used for like and corresponding parts of the various drawings.

FIG. 1 illustrates a system 10 operable to manage activities associated with products being supplied from vendors to an entity. System 10 may manage activities associated with outsourcing one or more products, which includes managing and tracking risk related to outsourcing products to one or more vendors together with specifying and tracking performance metrics associated with the performance of the selected vendors. Certain embodiments of system 10 include vendors 102, third-party information sources 104, an administrative computer 106, and a vendor management server 108. The components of system 10 may communicate with one another over a network 110 and/or any other suitable communication system.

System 10 may enable the vendor management process with suitable risk identification, management actions, and analytics built into the process through use of vendor management server 108. System 10 may include a risk mapping engine 122 and/or an action mappings database 138 that indicate, among other things, which management actions should be performed to mitigate and/or control any identified risk. This action mappings database 138, in certain embodiments, may list all identifiable risks for a vendor management process of an entity and indicate which management actions should be performed. The action mappings database 138 may be accessible to all components and participants of a vendor management process.

System 10 may allow early risk identification that occurs via a category risk assessor 124 and/or a category standards database 140 that associate product categories with particular risk types. This may occur before any vendor or potential vendor is selected. In the context of a particular transaction with a particular vendor, a transaction risk assessor 126 may allow for assessment of risk based on the product via accessing the category standards database 140 together with transaction-specific risk associated with the transaction being executed with the selected vendor. Among other things, the transaction level risk assessment may result in automatically inserting specific provisions in a contract according to any identified risk, and this insertion may occur prior to the contract's execution. The contract provisions may relate to certain management actions that will be performed to mitigate identified risk. In certain embodiments, the action mappings database 138 may include the contract provisions that should be specified for any contract to mitigate risk and/or certain characteristics of such provisions.

To gain a view of the risk to an entity associated with all products/transactions supplied by a particular vendor, transaction aggregator 128 of system 10 may allow for aggregation of the results of individual transaction risk assessments. Vendor profiler 130 of system 10 may facilitate management of a vendor through creation, manipulation, and viewing of a vendor profile that aggregates any calculated risk and performance information related to a particular vendor. A risk manager designation feature 132 may include functionality for determining whether a vendor manager should be designated for a vendor, the vendor manager responsible for facilitating management of any risk elements identified within the vendor profile. System 10 may also incorporate a distributed control function, where an internal control function 136 associated with an organization within an entity implements procedures to ensure adherence and quality completion of the requirements of a vendor management process in line with the requirements established by an entity control function 134.

Although the embodiment of system 10 illustrated in FIG. 1 depicts several functions as part of a vendor management server 108, it should be noted that these features may be distributed across any suitable number of servers, computers, and vendor management participants, where appropriate.

System 10 may allow management of outsourcing events to a vendor for any entity considering use and/or using any product from a vendor. As used herein, “product” refers to a good, service, any other suitable deliverable that potentially may be supplied by a vendor, and/or any suitable combination of the preceding. As non-limiting examples, an entity that uses system 10 may be any suitable enterprise such as a bank, brokerage house, investment firm, consulting firm, insurance agency, law firm, restaurant, retail store, shipping service, manufacturing facility, transportation service, collection agency, and/or any other suitable entity. Entities may comprise one or more organizations or lines of business. For example, a bank entity may comprise mortgage, consumer real estate, on-line banking, long-term investment, and/or any other suitable lines of business. Certain embodiments of system 10 may provide vendor risk and performance management according to such individual lines of business, at the entity level, and/or any suitable combination of the preceding (e.g., for multiple lines of business).

A vendor management program may comprise any suitable framework of governance, processes, and tools to manage vendor risk and performance annually, or at any other frequency desired. As part of such a framework, vendor managers and vendors can submit program deliverables, which enable the entity to assess, manage, and mitigate vendor performance and risk issues in a timely manner.

System 10 may define and/or implement certain processes of a vendor management program according to phases, such as a plan phase, source phase, manage phase, and govern phase. A plan phase may be a phase of a vendor management process in which a line of business or organization within the entity identifies a need for outsourcing. The organization may create a purchasing/outsourcing strategy, which may form the basis of contractual requirements to which the vendor will be managed.

A source phase of a vendor management process may be triggered by acceptance of a purchasing/outsourcing strategy and/or by a request to otherwise modify an existing contract or relationship with a vendor. During the source phase, an entity and/or an organization within the entity may complete due diligence associated with proposed vendors, complete a transaction level risk assessment of one or more proposed vendors, and/or execute the contract with the selected vendor.

During the manage phase of a vendor management process, vendor managers and line of business process owners may work together to manage the performance and risk related to the outsourced products. For example, vendor managers may be required to know certain types of information about the vendors that they manage and understand the risks with every vendor in their portfolio. In certain embodiments, a manage phase of a vendor management process is triggered by execution of a contract.

A govern phase of a vendor management process may comprise comprehensive governance and ongoing oversight of the vendor management process. This may be accomplished via a governance structure; routines, requirements, and mechanism for approvals, exceptions, and escalations as issues arise; and requirements for governance as mandated by participants associated with an internal and/or entity level control function; metrics, reporting, communications and training; any other suitable governance framework; and/or any other suitable combination of the preceding.

An entity may be concerned with various types of risk (or risk elements) involved in utilizing products supplied by a vendor, such as vendor 102a. The risks may be defined by an entity, line of business, and/or external rules and standards. Possible types of risk that an entity may identify using system 10 include information protection and privacy, business continuity, regulatory standards, supply chain protocols, geographic presence, customer contact, subcontractor, operational, reputational, and/or any other suitable risk type.

The information protection and privacy category may include the risk of inappropriate disclosure of information and/or the inadvertent loss of information. For example, whether a vendor stores information associated with employees of an entity may bear on the information protection and privacy risk type. Other risk elements that may relate to information protection and privacy include protection of customer, employee, or sensitive data; data transmission and access management; physical security; record retention; and/or any other suitable risk element.

The business continuity risk type may include the risk that a vendor may not be able to provide products because of lack of redundancy, minimal capacity, and/or any other suitable reason. For example, whether a shipping service vendor has backup procedures in place in the event of a failure in the primary mode of transportation may bear on the business continuity risk type. Other risk elements that may relate to business continuity risk include the existence of contingency plans, amount of processing locations, quantity and nature of vendors that provide products to a particular vendor, line of business plan, testing procedures, and/or any other suitable category.

The regulatory standards risk type may include the risk that procedures and/or equipment used by a particular vendor may violate various regulatory standards required of any applicable entity and/or the particular vendor. Certain regulatory risks that may be more present when products are provided by vendors include those related to information security, privacy, foreclosure, fair lending, and debt collection. To the extent that services provided by a vendor may impede a bank entity's ability to comply with banking regulations, those risks may be identified as well. For example, a financial institution such as a bank in the United States may need to manage risk to meet requirements imposed by the government, such as those specified in statutes such as the USA Patriot Act, the Gramm-Leach-Bliley Act, and the Sarbanes-Oxley Act. Banks in the United States are also regulated by the Office of the Comptroller of the Currency (OCC) and may need to mitigate risks imposed by having to comply with OCC regulations. Other risk elements that may relate to the regulatory standards risk include particular policy/guidelines required, regulatory impact, financial impact, people/processes/systems required for compliance, previous operational risk assessments, requirements for ongoing reporting of applicable controls, and/or any other suitable risk element.

The supply chain protocols risk type may include the risk involved in managing the supply chain of a particular vendor. For example, whether a shipping services vendor adheres to guidelines specified in a supply chain protocol scorecard may bear on the supply chain protocols risk type. Other risk elements that may relate to the supply chain protocols risk type may include supply chain management participation, existence of negotiated contracts, supply chain protocol tier and rating, requirements for ongoing reporting, and/or any other suitable risk element.

The geographic presence risk type may include the risk involved in utilizing a particular vendor that maintains some part of its operations in one or more other countries. For example, whether a vendor is providing products from a region with economic/political instability may bear on the geographic presence risk type. Other risk elements that may relate to the geographic presence risk type include information protection, remote management of geographically diverse assets, remote assessment of geographically diverse assets, continuity and interactions with geographically diverse assets, and/or any other suitable risk element.

The customer contact risk type may include the risk involved when a particular vendor has contact with customers of an entity. For example, the extent of contact between a shipping services vendor and customers of an entity may bear on the customer contact risk type. Other risk elements that may relate to the customer contact risk type include the extent of customer contact, type of customer contact (e.g., in person, email, phone, postal mail), media and reputation exposure, and/or any other suitable risk element.

The subcontractors risk type may include the risk involved in the nature of the relationship between a particular a vendor and any of its subcontractors. For example, whether a web hosting vendor uses a sole third-party company to manage all the technical support needs of an entity may bear on the subcontractors risk type. Other risk elements that may relate to the customer contact risk type include whether subcontractors are used for services associated with the entity itself, control measures in place for subcontractors, and/or any other suitable risk element.

A reputational risk type may include the risk that negative press exists and/or may exist in the future related to the vendor. The risk type may also comprise the risk that negative press related to the vendor will affect the reputation of the entity and/or the relationship between the entity and the vendor.

As described in more detail below, system 10 includes functionality for identifying inherent risk at the element level associated with supplying a product from a vendor. The inherent risk may be identified based on a product category associated with the supplied product and/or the particular vendor selected to supply the product. Controlling activities or management actions may be performed, which may impact the inherent risk. Residual risk may be calculated by adding the inherent risk with a risk reduction value associated with management actions. Residual risk comprises the risk (overall and at the risk element level) to an entity of outsourcing a product from a vendor after the inherent risk has been calculated and controls/management actions have been performed to reduce the overall risk. In certain embodiments of system 10, inherent risk, management actions, and residual risk may be identified at the risk element level.

System 10 may have various users that utilize its functionality and/or are assigned responsibilities according to the vendor management program implemented by vendor management server 108. For example, a sourcing associate may be involved in the selection of a particular vendor to provide a product. The sourcing associate may be involved in conducting any transaction risk assessments and/or may be assigned certain tasks related to any management actions necessitated by any identified risk. A vendor manager may also be designated to handle tracking management actions identified for reducing risk associated with a vendor. Additionally, users may be assigned to initiate control function testing at the entity level and/or within a line of business, where appropriate.

A network 110 represents any suitable network that facilitates communication between the components of system 10. For example, third-party information source 104 may communicate data, such as data bearing on the risk of using a vendor 102, to vendor management server 108 for consideration during a transaction risk assessment. Network 110 may include any interconnecting system capable of transmitting audio, video, signals, data, messages, or any combination of the preceding. Network 110 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an entity intranet, other suitable communication link, any other suitable communication link, including combinations thereof operable to facilitate communication between the components of system 10.

Vendor 102 represents any suitable type of entity in any suitable type of industry capable of supplying one or more products to an entity. As non-limiting examples, vendor 102a may be a shipping services company and vendor 102b may be a web services company operable to host a website and/or data of an entity to provide access to entity's customers, for example. In certain embodiments of system 10, vendor 102a and 102b may have a relationship. For example, vendor 102b may be a subcontractor for a service supplied by vendor 102a to an entity. As another example, vendor 102b may be a subsidiary of vendor 102a. An entity and/or various lines of business within an entity may have products supplied by either or both of related vendors 102a and 102b. Such factors may bear on the inherent risk associated with a particular transaction and/or when multiple transactions are aggregated.

Third-party information source 104 represents any source of information that may bear on the risk in utilizing the products provided by a vendor. Third-party information source 104 may be a financial institution, government agency, credit bureau, news firm, and/or any other suitable information source. The information provided by third-party information source 104 may include certain environmental factors that did not come directly from a vendor and/or were learned after conducting a survey in connection with a transaction risk assessment. For example, vendor 102 may be subject to a consent order issued by the OCC requiring more stringent practices for certain processes. As another example, an entity may be subject to an OCC consent order, where a particular vendor provides the entity with the services subject to the new requirements. Other examples of environmental factors include results of audits on the practices of a vendor 102 and/or an entity, service areas designated as high risk, changes in the structure of applicable oversight agencies, media attention, customer complaints, news/media/legal settlements, and/or any other suitable factor. Third-party information source 104 includes any suitable hardware, software, or logic (including a processor) to carry out reporting operations to vendor management server 108 or any other suitable destination.

Administrative computer 106 represents any suitable components that facilitate management, use, and/or manipulation of the functions of vendor management server 108. Administrative computer 106 may be associated with a particular entity. A user may use administrative computer 106 to create or update the rules used by vendor management server 108 to determine risk associated with a vendor 102. As another example, a user may use administrative computer 106 to update the risks associated with particular product categories in a category standards database 140 and/or an action mappings database 138 on vendor management server 108. As another example, a user may use administrative computer 106 to define a minimal set of questions related to a vendor proposed to supply a product to an entity during a transaction risk assessment. The user may also define dynamically-triggered questions that may only need to be asked when certain responses are given to one or more questions in the minimal set of questions. In certain embodiments, the user may define contract provisions to be inserted into a contract in response to certain vendor selections during the transaction risk assessment. These may be stored in the category standards database 140, action mappings database 138, and/or in any other suitable repository.

Additionally, a user of administrative computer 106 may use entity control function features of vendor management server 108 to define a control function test. A user within a specific organization or line of business within the entity may then use an internal control function feature of vendor management server 106 to implement the control function test on the line of business and/or for specific vendor managers within a line of business, where appropriate.

A user of administrative computer 106 may utilize different views of various risk assessments, vendor profiles, and/or other features of vendor management server 108 through a graphical user interface (“GUI”) 112. GUI 112 displays information received from vendor management server 108 to a user of administrative computer 106. GUI 112 is generally operable to tailor and filter data entered by and presented to the user. GUI 112 may display a vendor profile that shows identified risk elements, scoring associated with those risks, any completed management actions assigned to mitigate those risks, and/or any remaining residual risk associated with the identified risk elements. GUI 112 may include filter features, where appropriate, to allow a user to select different views of the data. For example, a user may drill down into a business continuity risk type to see the specific risk elements that form the basis for inherent risk associated with business continuity. Additionally, a filter may allow a user to see any identified management actions for each risk element and the remaining residual risk after taking into consideration any management actions.

In certain embodiments, GUI 112 may be configured to display particular views of information based on the role of a user in the vendor management process. For example, a vendor manager only associated with a particular organization or line of business within an entity may be limited to viewing risk and performance information associated with products supplied by the vendor to the specific line of business. On the other hand, an entity-level vendor manager may have the ability to view information associated with multiple lines of businesses within the entity. Certain views may allow for viewing risk and performance information according to the line of business (e.g., all vendors for a particular line of business and/or for multiple lines of business), certain risk elements (e.g., risk element scoring aggregated for all vendors for a particular line of business and/or for multiple lines of business), and/or for one or more transactions of a vendor or for multiple vendors.

GUI 112 may comprise a plurality of displays having interactive fields, pull-down lists, and buttons operated by the user. GUI 112 may include multiple levels of abstraction including groupings and boundaries. It should be understood that the term GUI 112 may be used in the singular or in the plural to describe one or more GUIs 112 and each of the displays of a particular GUI 112.

Vendor management server 108 represents any suitable combination of software and/or hardware for managing activities associated with an entity being supplied with products from one or more vendors 102. Vendor management server 108 includes functionality that may facilitate risk identification and mitigation of the identified risk at the earliest possible point within the vendor management process (e.g., before any potential vendor is selected to provide a particular product). Vendor management server 108 may also include features for analyzing information related to vendor risk/performance and applying scoring values according to defined rules.

Vendor management server 108 may include a network server, any suitable remote server, a mainframe, a host computer, a workstation, a web server, a personal computer, a file server, or any other suitable device operable to carry out vendor management operations. In some embodiments, vendor management server 108 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. As one non-limiting example, certain features of vendor management server 108 may utilize a Windows™ personal computing platform running Microsoft Excel™ spreadsheet software. The functions of vendor management server 108 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, vendor management server 108 may include any suitable component that functions as a server.

In certain embodiments, vendor management server 108 includes a network interface 114, a processor 116, and a memory 118.

Network interface 114 represents any suitable device operable to receive information from network 110, perform suitable processing of the information, communicate to other devices, or any combination of the preceding. For example, network interface 114 may receive a request to perform a risk assessment for a particular vendor from administrative computer 106. As another example, network interface 114 may receive vendor information for a vendor 102 from a third-party information source 104. Network interface 114 represents any port or connection, real or virtual, including any suitable hardware and/or software, including protocol conversion and data processing capabilities, to communicate through a LAN, WAN, or other communication systems that allow vendor management server 108 to exchange information with the components of system 10.

Processor 116 communicatively couples to network interface 114 and memory 118. Processor 116 controls the operation and administration of vendor management server 108 by processing information received from network interface 114 and memory 118. Processor 116 includes any hardware and/or software that operates to control and process information. For example, processor 116 executes vendor management tool 120 to control the operation of vendor management server 108. In certain embodiments, processor 116 executes instructions when certain features of vendor management tool 120 are invoked, such as category risk assessor 124 to determine inherent risk levels associated with a particular product. Processor 116 may be a programmable logic device, a microcontroller, a microprocessor, any suitable processing device, or any suitable combination of the preceding.

Memory 118 stores, either permanently or temporarily, data, operational software, or other information for processor 116. Memory 118 includes any one or a combination of volatile or nonvolatile local or remote devices suitable for storing information. For example, memory 118 may include random access memory (RAM), read only memory (ROM), magnetic storage devices, optical storage devices, database and/or network storage, removable storage media, or any other suitable information storage device or a combination of these devices. While illustrated as including particular modules, memory 118 may include any suitable information for use in the operation of vendor management server 108.

In certain embodiments, memory 118 includes vendor management tool 120, action mappings database 138, category standards database 140, vendor contracts 142, vendor quality plans 144, vendor profiles 146, and control function data 148.

Vendor management tool 120 represents any suitable set of instructions, logic, rules, or code embodied in a non-transitory, computer readable medium and operable to facilitate the operation of vendor management server 108. Vendor management tool 120 creates and/or accesses data stored in action mappings database 138, category standards database 140, vendor contracts 142, vendor quality plans 144, vendor profiles 146, and/or control function data 148 in order to execute any suitable operations. In certain embodiments, vendor management tool 120 includes any suitable features for carrying out vendor management functions, such as risk mapping engine 122, category risk assessor 124, transaction risk assessor 126, transaction aggregator 128, vendor profiler 130, risk manager designator 132, entity control function 134, internal control function 136, and/or any other suitable feature. In particular embodiments of system 10, one or more individuals of an entity may be associated with each of these features to invoke operations and/or customize features for particular products, vendors, and/or lines of business within an entity.

Risk mapping engine 122 represents any suitable set of instructions, logic, rules, or code operable to determine the conditions under which a risk element may be identified and any suitable management actions for reducing the risk associated with the identified risk element. In particular embodiments, risk mapping engine 122 and/or action mappings database 138 may be used in one or more of a plan, source, manage, and/or govern phases of a vendor management process. In the plan phase, information may be used in determining if outsourcing the product is the right decision given the expected risk from the product being supplied. In the source phase, specific risks may be identified and may need to be mitigated. In the manage phase, additional risk identification may occur while also focusing on mitigating and managing the risk that has already been identified. In the govern phase, this information may be used as input to ensure the risk identification and mitigation are occurring appropriately throughout the rest of the vendor management process. Additionally, in the govern phase this information may be used to aggregate all risk across a vendor population to ensure that risk is within a reasonable level (e.g., in comparison to a risk appetite). Thus, the view may be for one vendor, all vendors in a line of business, for a specific type of risk across one or more vendors, and/or for an entire entity.

Risk mapping engine 122 may access information stored in action mappings database 138 to perform its functions. Action mappings database 138 may include all risks that are identifiable within a vendor management program implemented by an entity, the tool that should be used to identify that risk, the vendor management phase when risk identification should occur (e.g., the identification phase for a particular risk element), any management action that should be undertaken to control and/or reduce the risk related to the identified risk element, the vendor management phase when the management should occur (e.g., the performance phase), the tool that should be used to implement the management action, and/or any other suitable combination of the preceding. For example, action mappings database 138 may indicate that information security risk should be identified in the source phase of a vendor management process using category risk assessor 124 and/or category standards database 140. The action mappings database 138 may indicate that a management action for the identified information security risk includes incorporating a provision into a contract that requires monitoring of the data shared with and/or used by a vendor 102. The action mappings database 138 may indicate, in certain embodiments, that the management action is seeking higher level approvals prior to execution of the contract outsourcing the product to a vendor 102.

As another example, action mappings database 138 may indicate that a business continuity risk should be identified in the source phase of a vendor management process using transaction risk assessor 128. The action mappings database 138 may indicate that management action for the identified business continuity risk includes requiring an on-site business continuity assessment during the manage phase of the vendor management process. This may be recorded as a deliverable for a vendor manager in a vendor quality plan 144, for example.

Certain embodiments of action mappings database 138 may include any suitable number of risk identification-mitigation mappings per risk element. For example, a business continuity risk element may include a primary identification-mitigation mapping, a secondary identification-mitigation mapping, a tertiary identification-mitigation mapping, and/or any other suitable number of identification-mitigation mappings. Each mapping may include any or all of the information described above for identifying risk and associated management actions. The result is a vendor management process that allows for identification of risk associated with a particular risk element and performance of management actions for that risk element during multiple phases of a risk management process. Additionally, information captured from each of the phases may be available in downstream phases.

Where appropriate, action mappings database 138 may include a risk score to apply when a certain risk element is identified. Additionally, action mappings database 138 may also include a risk reduction value associated with completion of a management action. Having all risks and associated scoring metrics in action mappings database 138 may facilitate retrieval by any component and/or participant of a vendor management process, such as any of the functional modules of vendor management tool 120. This also may allow for consistency in implementing a vendor management process for multiple outsourced products across multiple lines of business of an entity.

As one non-limiting example, action mappings database 138 may be setup as a spreadsheet with each identifiable risk element and/or combination of risk elements listed on a row of the spreadsheet. For each risk element and/or combination of risk elements, the row may also contain any suitable number of identification-mitigation mappings as noted above with associated scoring metrics, where appropriate.

In certain embodiments, risk mapping engine 122 accesses action mappings database 138 and provides information from action mappings database 138 to administrative computer 106 for display on GUI 112. Risk mapping engine 122 may filter the risks shown by risk type, tool for identification, phase for identification, management action, phase for performance of the management action, any other suitable factor, and/or any suitable combination of the preceding. By using such features, a user may be able to easily determine possible risks associated with risk types, all risk elements identified by a particular tool, the risk elements identified in particular phases, the type of management actions available for controlling/reducing risk, and what management activities may be required during particular phases. This may allow a user to obtain an understanding of what requirements may be associated with an outsourcing event to obtain a controlling environment suitable for ensuring that the vendor is performing as expected.

Category risk assessor 124 represents any suitable set of instructions, logic, rules, or code operable to determine risks inherent with outsourcing a product based on the product's category. In certain embodiments, category risk assessor 124 may be used to determine inherent risk prior to selection of any vendor or potential vendor to supply the product. Category risk assessor 124 may access category standards database 140 in order to determine risks inherent to a particular product category.

Category standards database 140 may include a mapping between particular product categories and risk elements associated with that product category. For example, a shipping services product category may be mapped to particular risk elements. Category standards database 140 may also include a score embodying the amount of risk a particular product category includes for a particular risk element. Category standards database 140 may also indicate whether any management actions will be required for products in a particular category. As another example, category risk assessor 124 may identify risks associated with a particular product category by accessing category standards database 140. Then, category risk assessor 124 may access action mappings database 138 to determine additional information associated with each risk element, such as a risk score and associated management actions. As such, category risk assessor 124 may provide some risk assessment information independent of any vendor selected to supply a product.

Category risk assessor 124 and/or category standards database 140 may provide a first view into risk associated with an outsourcing event and any required management actions, e.g., in a plan phase of a vendor management process. This may avoid requiring a time and/or resource consuming detailed risk assessment for all vendors without any prior understanding of risk level. While additional risk identification and management actions may be determined subsequently, for example by transaction risk assessor 126, category risk assessor 124 and/or category standards database 140 may provide a starting point for further evaluation. The management actions dictated by a product category may be regarded as minimum management actions for a product belonging to a particular product category. Category risk assessor 124 and/or any other suitable component of the vendor management process may insert these into a vendor quality plan 144 used to track management activities for the vendor once selected to supply the product.

In certain embodiments, category risk assessor 124 accesses category standards database 140 and provides information from category standards database 140 to administrative computer 106 for display on GUI 112. Category risk assessor 124 may filter the risks shown by product category, where appropriate. By using such features, a user may be able to easily determine possible risks and management actions required for certain product categories.

Transaction risk assessor 126 represents any suitable set of instructions, logic, rules, or code operable to determine risks inherent with outsourcing a product to a particular vendor in the context of a particular transaction. In certain embodiments, transaction risk assessor 12 may be used to evaluate one or more vendors proposed for supplying a particular product to an entity. The results may include both the risk of the product being provided pursuant to a given contract/engagement together with the risk of using a specific vendor and how the product will be provided to the entity. To obtain the risks elements associated with a particular product category, transaction risk assessor may use the results derived from category risk assessor 124. Using these results may ensure efficient use of available resources and ensure consistency through the plan and source phases of a vendor management process.

Transaction risk assessor 126 determines responses to a series of questions related to a vendor proposed to supply a product to an entity. The questions may be multiple choice questions where answers may be selected from a set of predetermined responses, wherein the multiple choice questions are used to identify and measure risk elements associated with the vendor. In certain embodiments, transaction risk assessor 126 may include instructions for associating a score with each of the predetermined responses. Certain questions may have yes/no responses. For certain questions, only one of the predetermined responses may be selected for a response. In certain questions, one or more of the predetermined responses may be selected (e.g., for listing the multiple ways that a shipping vendor supplies products).

These questions may be broken into unique groupings that summarize risk levels for a specific risk type. The question set may be expandable, adapting to the specific risk associated with a transaction with dynamically-triggered questions. Transaction risk assessor 126 may specify a set of minimum questions that all transactions must answer, and if through answering the question set there is the potential for risk then additional questions may be dynamically-triggered for response.

Responses to questions posed by transaction risk assessor 126 during a transaction risk assessment may be determined by collecting responses to a survey directly from a vendor 102, accessing information from a third-party information source 104, and/or from any suitable combination of the preceding.

Transaction risk assessor 126 may be used for all new deals in the source phase of a vendor management process. Transaction risk assessor 126 has built-in algorithms that produce a ‘score’ to trigger additional risk management actions prior to contract finalization as well as risk management actions that are required after execution of the contract during the manage phase of a vendor management process. Each question has multiple answer options that are each assigned a question value, wherein the question values may fall within a predetermined value range. Transaction risk assessor 126 may include rules that indicate that questions that relate to a certain risk type may have more influence than questions that relate to other risk types (e.g., business continuity-related questions may be weighted more than questions related to geographic presence).

Management actions may be triggered based on an overall score for the risk assessment, selections made for specific risk elements, and/or according to any other suitable metric. If scoring for a transaction risk assessment is outside of a set threshold on a risk element and/or overall risk level, then management activities may be required either pre-contract execution or post-contract execution in the source and/or manage phase of a vendor management process. In particular embodiments, transaction risk assessor 126 may forego assigning management actions according to a tier level determined according to an overall risk score. Instead, management actions may be assigned based on determination of the existence of risk for particular risk elements. Such actions may be dictated by, for example, mappings included in action mappings database 138. Assigning management actions according to an identified risk element may provide management actions more commensurate with actual identified risk as opposed to assigning management actions according to overall risk tier level determined for a vendor for particular embodiments.

Transaction risk assessor 126 may include algorithms for assigning particular management actions based on identified risk and/or may access action mappings database 138 to determine appropriate management actions. One example of a management action stemming from a transaction risk assessment may be insertion of a provision into a contract between the vendor and the entity. This may occur prior to and/or be a part of the contract regarding the product being supplied by the vendor. For example, an information security risk element identified by transaction risk assessor 126 may trigger insertion of a provision into the contract that allows the entity to perform an onsite assessment of the vendor at periodic intervals during the contracting period. Transaction risk assessor 126 may include rules for automatically populating any such provisions in a vendor contract 142. The vendor contract 142 may be subsequently completed with other performance requirements of the vendor and/or other contract terms. Transaction risk assessor 126 may store any identified risks and associated management actions in a vendor quality plan 144 for a particular vendor 102. Thus, information obtained from the transaction risk assessment during the source phase may flow into the manage phase, where a vendor manager may ensure that particular management actions are performed at suitable times.

Over the course of a contract term, an entity and a vendor 102 may execute any suitable number of addendums to contracts for any suitable purpose. For example, extension of a contract term and/or changing the terms of service may invoke the need to execute an addendum to an original contract. When an addendum is executed for a specific contract, transaction risk assessor 126 may be executed to perform an additional transaction risk assessment. Between the time of the execution of the original contract and the addendum, action mappings database 138 may have been updated to change any preexisting risk-to-action mappings and/or to add additional mappings for newly-defined risk elements. A corresponding change may have been made to transaction risk assessor 126 to determine responses to an updated question set. The new transaction risk assessment will capture any identified risks prior to execution of the addendum, insert any suitable provisions into the addendum to the contract, and/or store any management activities in the vendor quality plan for the particular vendor 102.

In certain embodiments, transaction risk assessor 126 provides questions to be used during a transaction risk assessment to administrative computer 106 for display on GUI 112. GUI 112, in certain embodiments, may present a minimum set of questions included for all transaction risk assessments. In response to selection of certain responses in the minimum set of questions, GUI 112 may present one or more dynamically-triggered questions, which do not appear by default. GUI 112 may present any other suitable information such as a vendor contract 142 with automatically inserted provisions related to management actions and/or vendor quality plan 144, which may include all management actions designated for the vendor after the transaction risk assessment.

Transaction risk aggregator 128 represents any suitable set of instructions, logic, rules, or code operable to aggregate the results of completed individual transaction risk assessments for a vendor, as many times a particular vendor 102 will have multiple engagements with an entity. In certain embodiments, transaction aggregator 128 may aggregate transaction risk assessments of different vendors. For example, transaction aggregator 128 may aggregate the transaction risk assessments of vendor 102a and 102b if those entities have a relationship (e.g., if one is a subsidiary of the other).

Transaction risk aggregator 128 may aggregate individual transaction risk assessments in any suitable manner. Aggregation may capture the sum of the risk from all transaction risk assessments, such that the highest risk level associated with a vendor is what is being managed. For example, for certain questions transaction risk aggregator 128 may choose the response from the transaction risk assessment associated with the highest risk level. As another example, transaction risk aggregator 128 may determine a response as a superset of all responses chosen in each individual transaction risk assessment. In such examples, the aggregated response may correspond to a higher risk level than any individual response for a particular transaction risk assessment. As another example, transaction risk aggregator 128 may aggregate numerical responses by taking a sum of each individual response. This may be provided in ranges. For example, suppose that for three transaction risk assessments a question regarding the number of data records accessed and/or handled by the outsourced product were 20 to 50, 50 to 100, and 100 to 150. The aggregated response for this question may be 170 to 300. The risk level and/or risk score associated with this aggregated response may be different from the risk level associated with any individual response. Information associated with the aggregated risk assessment may be stored in vendor profile 146 associated with a particular vendor 102, where appropriate.

Once an aggregation has been established for a vendor 102, transaction risk aggregator 128 may be executed upon completion of any new transaction risk assessment for the vendor 102. In certain embodiments, the new transaction risk assessment may trigger aggregation only after execution of a related vendor contract 142 between the vendor 102 and the entity. Waiting until contract execution for aggregation may avoid a situation where a new transaction risk assessment is performed, but a contract was never executed (e.g., if the risk associated with having vendor 102 supply the product was too high). If the new transaction risk assessment is aggregated with the previously-existing transaction risk assessments, the aggregated response may be different if the new transaction risk assessment identifies a higher level of risk than any other transaction risk assessment for any particular risk element.

Additionally, transaction aggregator 128 may be configured to disaggregate any transaction risk assessment upon expiration of the contract term for the contract related to the transaction risk assessment. This may happen automatically and/or in response to a request from a participant in the vendor management process. If the disaggregated transaction risk assessment incorporated the highest level risk for any risk elements, disaggregation may reduce the management actions required for the particular vendor 102.

Transaction aggregator 128 may require a validation check for the completed aggregation by a vendor manager assigned to manage the vendor. As one example, vendor management tool 120 may provide a visual notification that a validation needs to be performed when a vendor manager logs into to use the tool. As another example, transaction aggregator 128 may send an electronic communication, such as electronic mail message, to a vendor manager with a notification that a validation should be performed on the aggregation. The validation check may be required after aggregation of a new deal, periodically (e.g., once per year), and/or at any other suitable time.

This assessment may require validation that the risks captured in the transaction risk assessment were appropriate and that the resulting risk levels have the proper management actions in place. If there are risks uncovered that are not captured in the aggregated risk assessment, then an individual transaction risk assessment may be updated to ensure the risks are in sync. If the assessment triggers new risks, then the monitoring and oversight activities for a vendor may be addressed to ensure the risk is covered. Because the aggregation duties of a vendor manager may be limited to such a validation check, the vendor manager's workload may be reduced in comparison with the workload if the vendor manager had to perform the aggregation manually.

Capturing risk assessment information at the transaction level and then aggregating each transaction risk assessment may allow both an aggregate view and a granular view of risk assessment information for a vendor. This may be provided to administrative computer 106 for presentation on GUI 112.

Vendor profiler 130 represents any suitable set of instructions, logic, rules, or code operable to create a vendor profile 146 comprising information related to risk and performance of a particular vendor 102 that supplies products to an entity. Vendor profiler 130 incorporates risk information from category standards database 140 for particular products supplied by a vendor, any transaction risk assessments, results of aggregating each transaction level risk assessment, and any vendor level activity that has changed the inherent risk attributes for a vendor. Vendor profiler 130 may access action mappings database 140 to determine whether any management actions should have been performed for any identified risks and to identify any risk reduction values associated with the management actions. Vendor profiler 130 may access vendor quality plan 144 to determine whether any management actions have been completed. Vendor profiler 130 may determine residual risk for each identified risk element according to inherent risk associated with an identified risk element and a risk reduction value. For example, vendor profiler 130 may reduce an inherent risk value by an amount equal to the risk reduction value for a management action to obtain the residual risk value associated with a particular risk element. This information may be stored in a vendor profile 146.

Vendor profiler 130 may include any suitable rules and/or thresholds for rating the residual risk remaining for a particular risk element. For example, vendor profiler 130 may designate that residual risk in the range of 0 to 15 to “satisfactory,” residual risk in the range of 16 to 39 to “needs improvement,” and residual risks of 40 and above to “does not meet” for a particular risk element. In certain embodiments, the thresholds ranges may be set to the same values for each risk element. In alternative embodiments, threshold ranges may be set to different values for certain risk elements. Thus, while a residual risk of “60” may not meet risk requirements for one risk element, a residual risk of “60” for another risk element may be satisfactory.

Vendor profiler 130 may access vendor contracts 142 and/or vendor quality plan 144 to determine performance requirements and performance measurements for contracts executed with a vendor 102 and the entity. For example, a performance requirement may be to meet a 99% uptime rate for a website hosting vendor 102 providing website hosting services to an entity. If the website has a 100% uptime rate, then vendor profiler 130 may determine the performance level to be satisfactory. Vendor profiler 130 may include any suitable rules to designate any suitable number of performance levels, e.g., “satisfactory,” “needs improvement,” and “does not meet.” The various performance levels may be designated based on how close the performance measurements are to a performance requirement in any suitable manner.

By providing a view of risk and performance through individual risk elements and individual performance metrics, vendor mangers may be able to better manage risk associated with a particular vendor 102. In other words, such a model may be distinct from a one-size-fits-all model in a tiered approach with high risk vendors and low risk vendors. A vendor manager may implement customized management activities tailored to specific risk elements designated as needing improvement. Understanding overarching risk for the portfolio becomes much easier with the aid of vendor profiler 130 and vendor profiles 146, given that the risk elements may be created for all vendors 102 and data structures for vendor profiles 146 may be built so the information can be aggregated for multiple views.

In certain embodiments, vendor profiler 130 provides information from vendor profiles 146 to administrative computer 106 for display on GUI 112. Risk elements may be aggregated across the portfolio of vendors creating multiple views. GUI 112, in certain embodiments, may present information from one or more vendor profiles 146 in any suitable manner. For example, GUI 112 may provide information from vendor profiles 146 according to a specific vendor, product, product category, risk element, transaction, and/or any other suitable view.

Risk manager designator function 132 represents any suitable set of instructions, logic, rules, or code operable to stratify where in a vendor management process risk management oversight is required, and thus that a ‘Vendor Manager’ needs to be assigned. Risk manager designator feature may determine that a vendor manager is required based on results of transaction risk assessments for new deals. Risk manager designator 132 may access a vendor profile 146 and determine that the residual risk level of certain risk elements for a vendor necessitate designation of a vendor manager. There may be a key risk element that has a residual risk beyond a certain threshold and/or multiple risk elements that have residual risk levels beyond certain thresholds. As another example, a management action necessitated by an identified risk may be on a list of management actions for which a vendor manager is required. As another example, risk manager designator function 132 may consider whether the vendor 102 supplies products to multiple lines of business, the amount of money spent by the entity for the products of the vendor 102, and/or any other suitable criteria.

Risk manager designator function 132 may be executed at any suitable time, where appropriate. For example, risk manager designator function 132 may be executed following a transaction risk assessment, a recalculation of residual risk level by vendor profiler 130, modification of definitions in the action mappings database 138, modification of category standards 140, and/or in response to any other suitable trigger. Risk manager designator function 132 also may be executed following contract expiration of a contract associated with a vendor. Where residual risk levels drop below a certain risk level for one or more risk elements, risk designator function 132 may determine that a vendor manager currently assigned to manager a vendor 102 may no longer be needed, in particular embodiments.

Entity control function 134 and internal control function 136 represent any suitable set of instructions, logic, rules, or code operable to form a distributed control function for overseeing execution of the vendor management process within an entity. In particular embodiments, entity control function 134 is associated with an entire entity while an internal control function is associated with an organization or line of business within the entity. Together control functions 134 and 136 may facilitate testing of various pieces of a vendor management process within an entity, such as whether sourcing associates, vendor managers, and/or other vendor management participants are performing their functions as required by a vendor management process. The quality of execution of any deliverables may also be tested.

Entity control function 134 may have responsibility for identifying a testing methodology. This methodology may include creation of testing scripts, testing guidelines, sampling methodology, and other guidance required to execute the testing/oversight appropriately. The testing methodology may be updated periodically (e.g., on a quarterly basis) and communicated to internal control functions 136 and participants associated with internal control function 136 within each line of business.

The sampling methodology may define any suitable conditions for testing to occur. The sampling methodology may define which participants/transactions in a vendor management process should be subjected to testing (e.g., vendor managers assigned to vendors that supply products in a particular product category, transactions designated with an overall high risk, and/or transactions that involve a monetary value that exceed a certain threshold). The sampling methodology may also specify the times at which testing will occur. For example, the testing may occur at defined times (e.g., after a specified time period after execution of a contract), periodically (e.g., monthly, yearly, etc.), and/or in response to certain triggers (e.g., in response to completion of a transaction risk assessment and/or after the contract term for a transaction expires).

A test script may comprise a series of questions related to a vendor management process. In certain embodiments, a test script may relate to various phases in the vendor management process (e.g., plan phase, source phase, manage phase, govern phase), different roles in the vendor management process (e.g., sourcing associate, vendor manager), features/data available in particular vendor management tools/databases (e.g., tools used for transaction risk assessment such as vendor management tool 120 and/or transaction risk assessor 126), any other suitable pivot in the vendor management process, and/or any suitable combination of the preceding.

For example, test scripts associated with a plan or source phase of a vendor management process may test adherence to requirements for actions associated with or completed during a plan and/or source phase of a vendor management process such as purchasing/outsourcing strategy requirements, due diligence standards, whether or not a transaction risk assessment was completed, whether a contract includes appropriate provisions, whether appropriate product category is associated with the product being supplied by the vendor, whether changes to material terms of a contract in an addendum obtained appropriate approvals, whether deviations from standard requirements of a vendor management process obtained appropriate approvals, any other suitable test checks, and/or any other suitable combination of the preceding.

As another example, test scripts associated with a manage phase of a vendor management process may test adherence to requirements for actions associated with or completed during a manage phase of a vendor management process. Such test scripts may be related to a vendor management participant's knowledge of a vendor, knowledge of contracts associated with a vendor, knowledge of completion of management routines and possession of evidence of completion of those routines, maintenance of vendor quality plans and possession of evidence related to completion of management actions, maintenance of performance requirements/measurements in a vendor scorecard, any other suitable test checks, and/or any other suitable combination of the preceding.

Test scripts may score results in any suitable manner. For example, in certain embodiments, an internal control function participant facilitating execution of an control function test through GUI 112 of administrative computer 106 may rank compliance with each test check on a scale from 0 to 3, where “0” is selected if no data indicating compliance with the requirement is available, “1” is selected if criteria is not met for the test check, “2” is selected if criteria is mostly met for the test check, and “3” is selected if criteria is fully met for the test check. Each test check may have an associated weighting factor (e.g., high, medium, or low, where high is associated with a multiplicative factor of “9”, medium is associated with a multiplicative factor of “5”, and low is associated with a multiplicative factor of “1”). A certain test check may be disregarded when the requirement does not apply to the tested situation (e.g., a requirement may not be necessary if total contract value is below a specified threshold). In such cases, an “N/A” may be selected. For each test check, internal control function feature 136 may multiply the rank selected for the test check by the multiplicative factor of the test check to achieve a score for the test check. In the scheme described, a higher calculated score corresponds with better adherence to the defined vendor management process. Internal control function feature 136 may sum the individual scores for each test check to determine an overall score. In certain embodiments, scores exceeding a specified threshold (e.g. 80% of total possible) may be a passing test. Any suitable thresholds may be set, such as for fail, low pass, and/or high pass. Note that internal control function feature 136 may be configured to exclude points from test checks that do not apply from the total points possible so that scoring related to those test checks have no bearing on a final score.

Internal control functions 136 may test their respective line of business based on the established methodology from the entity control function 134. Internal control function 136 may be required to test all requirements set by the entity control function 136, and may go beyond such requirements to implement testing tailored to a specific line of business. Internal control functions 134 may load testing results into a central repository, such as control function data 148. Internal control functions 134 may identify any issues noted with the execution of the vendor management process and escalate to entity control function 134, where appropriate.

Internal control functions 134 may also identify issues that impact multiple lines of business, which may result in modification of control function test defined by entity control function 134 and/or the vendor management process itself. Participants associated with internal control functions within each line of business may provide coaching and/or training to individuals within their lines of business regarding effective controls and the overarching vendor management process.

Entity control function 134 may access results stored in control function data 148 to prepare scorecards reflecting an entity's adherence and quality of performing a vendor management process. Entity control function 134 may implement testing of a control function test on a line of business in order to verify control function testing by internal control function 136, identify where results are inconsistent, and adjust control function testing to account for inconsistencies. The entity control function 134 may identify any issues within a line of business, but also may identify program issues that impact multiple lines of business. Any issue encountered may also become feedback into the program. In response to identified issues, adjustments also may be made in the education of those implementing control function testing.

It should be noted that any of the data sets 138 to 148 may be integrated directly into vendor management tool 120, where appropriate. For example, vendor quality plans 144 may be integrated directly into vendor management tool 120. This may help to facilitate constant changes as management actions and/or performance metrics are added and completed for a vendor supplying one or more products to an entity.

In an exemplary embodiment of operation of system 10, a user of administrative computer 106 instructs vendor management server 108 to execute category risk assessor 124 for a shipping service product. This occurs prior to selection of any vendor 102 or potential vendor 102. Category risk assessor 124 may identify several risk elements inherent with a shipping service product category by accessing category standards database 140. Category risk assessor 124 invokes risk mapping engine 122, which maps identified risks to management actions associated with reducing risk of the identified risk elements. The user views the results on GUI 112 and gains an understanding of the management actions that will be required of the shipping service product if outsourced.

The shipping service product will be outsourced and two different vendors 102a and 102b are chosen as potential vendors. Transaction risk assessor 126 executes transaction risk assessments on each of vendors 102a and 102b. The transaction risk assessment for vendor 102b revealed risk associated with certain risk elements a lot higher than those associated with 102a. As a result, vendor 102a is chosen for supplying the shipping service product to the entity. In particular embodiments, vendor 102b may be chosen even though a transaction risk assessment resulted in risk elements with higher risk levels. This may be because the performance deliverables expected of vendor 102b are desirable, risk reduction values expected upon completion of management actions that reduce the risk associated with certain risk elements, for any other suitable reason, and/or for any suitable combination of the preceding.

Before executing a vendor contract 142 related to this transaction, a contract provision is inserted requiring that vendor 102a implement a plan to create a backup procedure in case its primary method of transportation goes down.

Vendor 102a is already supplying other products to the entity. Transaction aggregator 128 aggregates the transaction risk assessment with the pre-existing transaction risk assessments completed for vendor 102a. Transaction risk assessor 126 and/or transaction aggregator 128 record performance requirements and/or management actions associated with identified risk elements in vendor quality plan 144.

Vendor profiler 130 uses category-driven risk elements identified by category risk assessor 124 and aggregated transaction risk assessments to create a vendor profile 146 with associated management actions for the vendor specified at a risk element level. Risk manager designation function 132 analyzes the vendor profile 146 for vendor 102a and determines that a vendor manager is needed for this vendor based in part on the amount of money paid to vendor 102a and the fact that vendor 102 supplies products to multiple organizations within the entity. The vendor manager may facilitate execution and compliance with performance deliverables and management actions designated in vendor quality plan 144.

An entity control function test associated with the plan/source phase is designated to be executed following the completion of an executed contract for a product in a shipping services product category. As such, a vendor management participant associated with internal control function feature 136 facilitates execution of the control function test by ranking compliance with the vendor management process through several test checks. The internal control function feature 136 stores the results in control function 148. Upon initial review, entity control function feature 134 flagged the test as failing. After further analysis, a participant associated with entity control function feature 134 discovers that instructions set for ranking compliance with several test checks had a weighting factor of “low” equating to a multiplicative factor of “1.” The participant discovers that this weighting factor should be “high” (with a multiplicative factor of “9”) for these test checks to be consistent with the vendor management model. This would have resulted in a passing test on the control function test in the situation described above. As such, the participant associated with the entity control function feature 134 modifies the control function test used for all organizations within the entity to have a weighting factor of “high” for those identified test checks.

A component of the system 10 may include an interface, logic, memory, and/or other suitable element. An interface receives input, sends output, processes the input and/or output, and/or performs other suitable operation. An interface may comprise hardware and/or software. Logic performs the operations of the component, for example, executes instructions to generate output from input. Logic may include hardware, software, and/or other logic. Logic may be encoded in one or more non-transitory, such as a computer readable medium or any other tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. The components of the systems and apparatuses may be integrated or separated. For example, vendor management server 108 may be integrated directly into administrative computer 106. As another example, the modules of vendor management tool 120 may reside on any suitable number of computers. For example, internal control function 136 may reside on a different computer and/or server than entity control function 134. Moreover, the operations of the systems and apparatuses may be performed by more, fewer, or other components. For example, certain embodiments of functions of vendor management tool 120 may rely on accessing action mappings database 138 directly rather than relying on risk mapping engine 122. Additionally, operations of the systems and apparatuses may be performed using any suitable logic comprising software, hardware, and/or other logic.

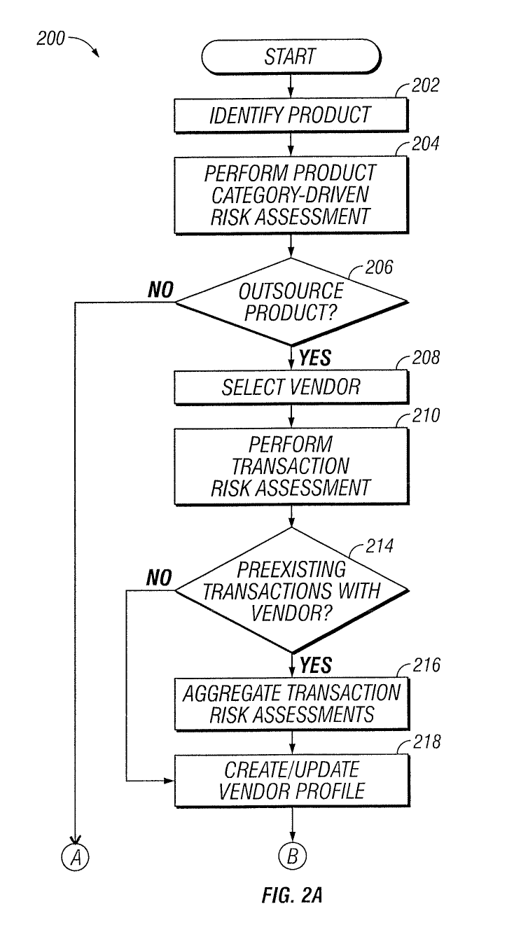

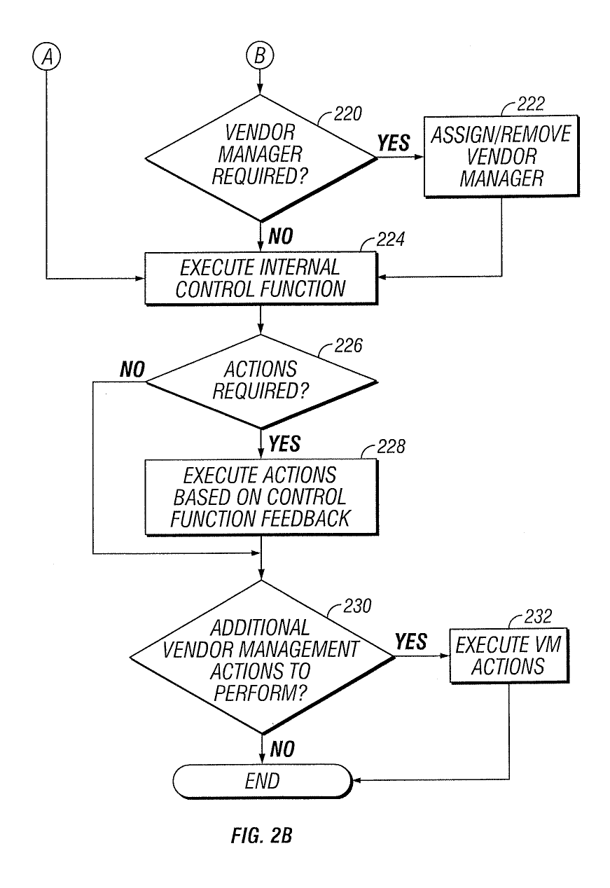

FIGS. 2A and 2B illustrate an example method 200 for managing activities associated with supplying products from a vendor to an entity. The method begins at step 202, where a product may be identified. At step 204, a product category-driven risk assessment is performed. During this step, risk elements inherent to a specific product category may be identified together with any associated management actions. At step 206, the method determines whether a product should be outsourced to a vendor. If so, a vendor is selected during step 208. At step 210, a transaction risk assessment is performed to identify risk elements associated with the selected vendor. Step 214 determines whether any preexisting transactions exist with the selected vendor. If so, the method aggregates any existing transaction risk assessments together at step 216. During this step, question responses to each individual transaction risk assessment may be aggregated such that the highest level risk associated with the responses to each transaction risk assessment are accounted for in the aggregated assessment. At step 218, a vendor profile is created and/or updated that incorporates cumulative risk and performance metrics associated with the selected vendor.

At step 220, the method determines whether a vendor manager is required to manage activities associated with the vendor. This step may analyze management actions and/or scoring related to specific risk elements to determine whether a vendor manager is required. If so, and/or if a vendor manager is no longer required, the method makes suitable changes at step 222. Where appropriate, the vendor manager keeps track of completion of assigned management actions and escalates issues as they arise.

At step 224, an internal control function is executed to test compliance with and quality of execution of a vendor management process within the entity. The internal control function may execute test scripts defined by an entity-level control function for overseeing that each step of a vendor management process, e.g. steps depicted in FIGS. 2A and 2B, have been performed suitably. At step 226, the method determines whether any actions are required following execution of the control function script. In certain embodiments, execution of a control function test by an internal control function may result in changes to a vendor management process, education of individuals who may be administering the control function test, and/or changes in the control function test itself. If so, the method facilitates those changes at step 228. At step 230, the method determines whether any additional steps of the vendor management process need to be performed. If so, these steps are executed at step 232. This may comprise starting back at step 202, performing an aggregation of transaction risk assessments at step 216, executing changes to vendor profile at step 218 as management actions are completed changing the residual risk scores for certain risk elements, determining whether a vendor manager is required at step 220, executing a control function test at step 224, and/or any other suitable steps. For example, steps 218 and 228 may be performed periodically on an on-going basis as needed. In certain embodiments, following step 232, the method may end.

Modifications, additions, or omissions may be made to method 200 disclosed herein without departing from the scope of the invention. The methods may include more, fewer, or other steps. Additionally, steps may be performed in parallel or in any suitable order. For example, when multiple vendors have been proposed to supply a product identified in step 202, step 210 may be performed any suitable number of times on each vendor and in parallel. A sourcing associate for the product (and/or any other suitable decision-maker) may base a decision to select a certain vendor according to the how much risk and which risk elements are implicated in a transaction risk assessment. A vendor proposed with a higher amount of risk may be selected, in certain situations, if for example proposed management actions performed during the manage phase of a vendor management process are believed to suitably mitigate such risk. As another example, method 200 may include another step wherein contract provisions associated with management actions may be selected according to risk elements identified in step 204 and/or step 210. As another example, method 200 may include a step whereby the questions in the transaction risk assessment are modified based on an analysis of an aggregated assessment (e.g., a vendor is asked more detailed questions related to certain risk elements during subsequent transaction risk assessments).

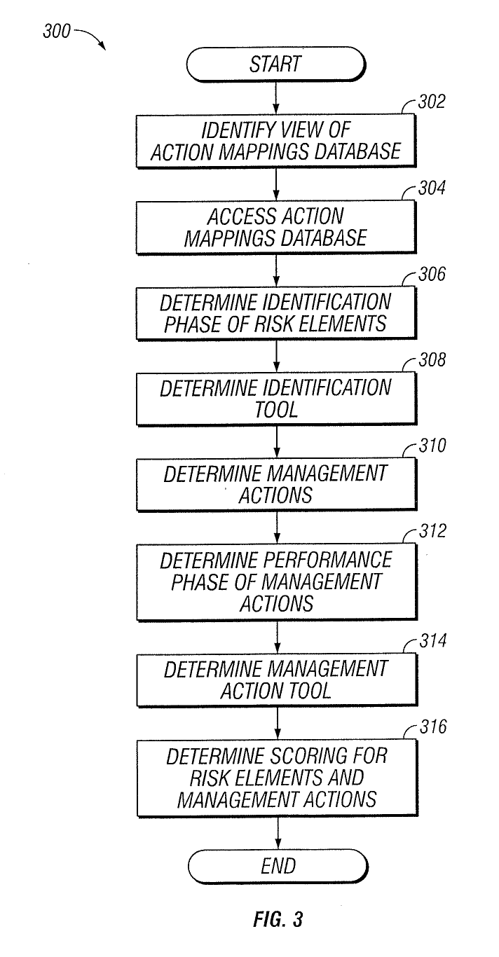

FIG. 3 illustrates an example method 300 for determining the conditions under which a risk element may be identified and any suitable management actions for reducing the risk associated with the identified risk element. The method begins at step 302, where a view of the action mappings database may be identified. For example, the view may be for a certain risk element, a vendor management phase for identification, and/or any other suitable filter. At step 304, an action mappings database is accessed. At step 306, an identification phase may be identified for a certain risk element, e.g., plan phase, source phase, manage phase. At step 308, an identification tool may be identified. For example, a contract, transaction risk assessment, and/or any other suitable tool may be used to identify one or more risk elements. At step 310, management actions associated with a particular risk element may be determined. At step 312, the method determines the performance phase for any identified management actions (e.g., plan phase, source phase, manage phase, govern phase). At step 314, a management tool may be identified for implementing the management action. Management tools include contracts, vendor manager deliverables, and/or any other suitable tool for implementing a management action. At step 316, scoring associated with identified risk elements and associated management actions may be identified. Then, the method may end.

Modifications, additions, or omissions may be made to method 300 disclosed herein without departing from the scope of the invention. The methods may include more, fewer, or other steps. Additionally, steps may be performed in parallel or in any suitable order. For example, step 308 may occur before step 306 in certain embodiments. As another example, steps 312, 314, and step 316 may all occur in parallel, in certain embodiments.

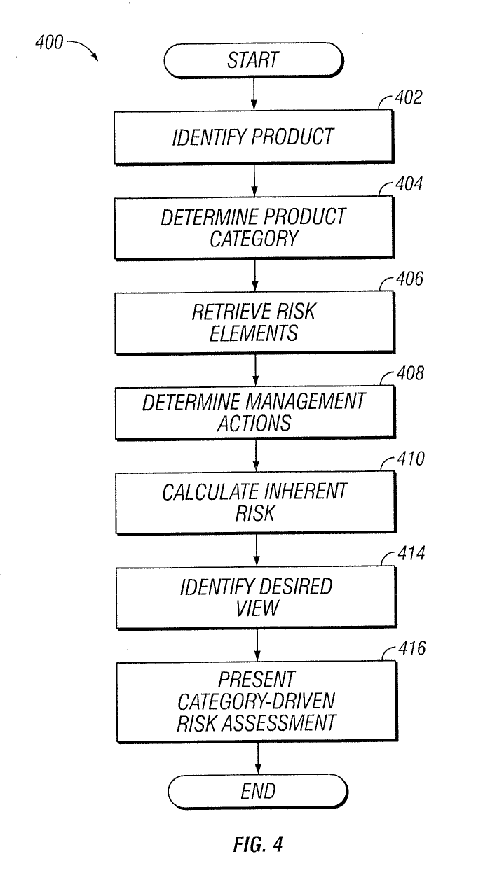

FIG. 4 illustrates an example method 400 for determining risks inherent with outsourcing a product based on the product's category. The method begins at step 402, where a product that may be outsourced by an entity is identified. At step 404, a product category associated with the product is identified. This may involve determining a selection of a user on a graphical user interface configured to display all defined product categories. At step 406, risk elements associated with the product category are retrieved from a category standards database, for example. At step 408, the method may determine management actions corresponding to the risk elements identified in step 406. This information may also be stored in a category standards database, where appropriate. At step 410, an inherent risk value may be determined for the identified product. The category standards database may include information about the product category's inherent risk value and/or the method may check an action mappings database for the risk elements identified at step 406. At step 414, a desired view is identified. This may involve receiving a selection from a user of a graphical user interface on an administrative computer. The view may be risk elements of a certain risk type, management actions that require performance in the certain phase (e.g. source phase, manage phase), and/or any other suitable view. At step 416, the category-driven risk assessment is presented on a graphical user interface according to the view selected at step 414.

Modifications, additions, or omissions may be made to method 400 disclosed herein without departing from the scope of the invention. The methods may include more, fewer, or other steps. For example, certain embodiments of method 400 may omit steps 414 and step 416. Additionally, steps may be performed in parallel or in any suitable order. For example, steps 406 and 408 may occur in parallel.

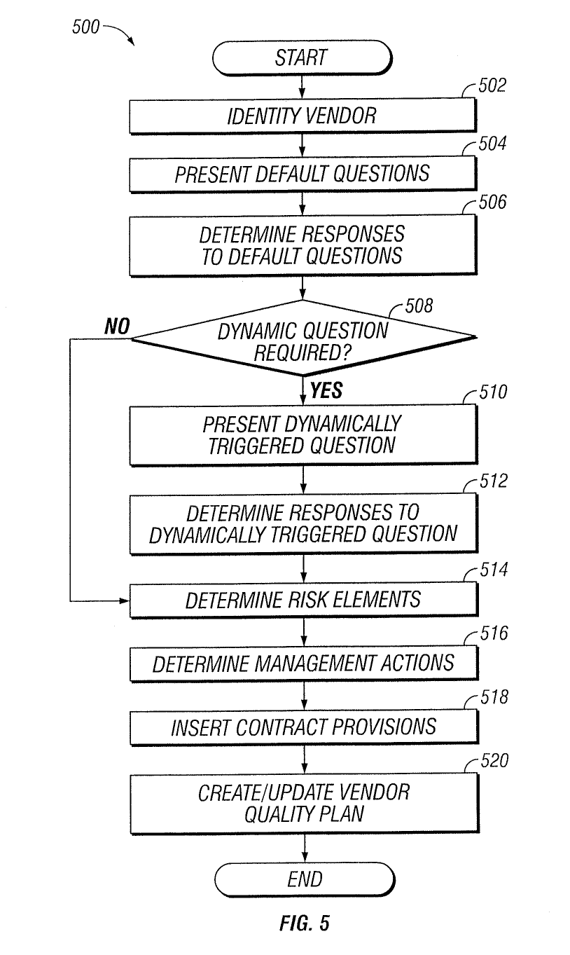

FIG. 5 illustrates an example method 500 for determining risks inherent with outsourcing a product to a particular vendor in the context of a particular transaction. The method begins at step 502, where a particular vendor is identified. At step 504, default questions in the transaction risk assessment are presented on a graphical user interface. At step 506, responses are determined to at least one of the default questions. At step 508, the method determines whether a dynamic question is required based on a response to one or more of the default questions. If so, the method presents the dynamically triggered question in step 510. At step 512, the method determines responses to dynamically-triggered questions. At step 514, risk elements are determined based on the results of the transaction risk assessment. At step 516, management actions are determined based on the identified risk elements. At step 518, contract provisions may be inserted into a contract with the vendor that relate to one or more management actions. At step 520, a vendor quality plan may be created and/or updated with management actions for the vendor and/or the vendor manager, performance provisions from the contract, and/or any other suitable information. Then, the method may end.

Modifications, additions, or omissions may be made to method 500 disclosed herein without departing from the scope of the invention. The methods may include more, fewer, or other steps. Additionally, steps may be performed in parallel or in any suitable order. For example, in certain embodiments no dynamic questions may be presented, such that steps 508 and 512 are omitted.

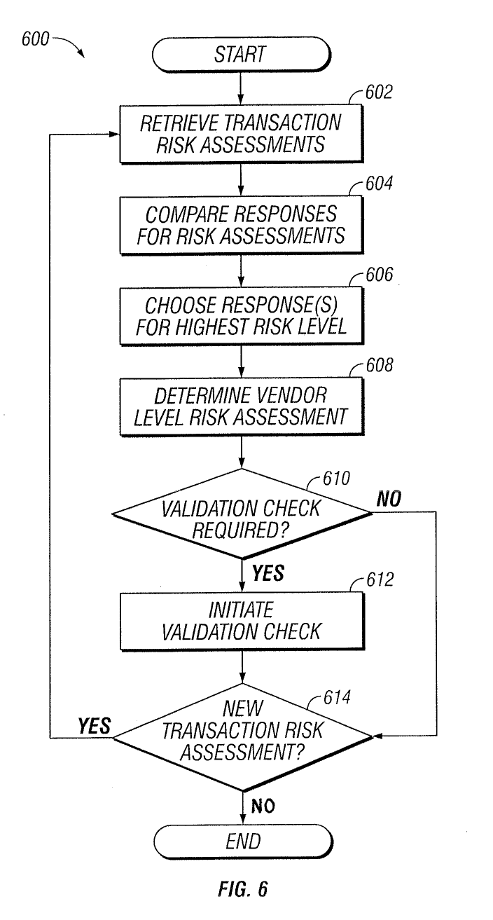

FIG. 6 illustrates an example method 600 for aggregating the results of completed individual transaction risk assessments for a vendor. The method begins at step 602, where transaction risk assessments are retrieved from any suitable database. Such information may be retrieved from a vendor profile, where appropriate. At step 604, the method may compare responses of each individual transaction risk assessment. At step 606, the method chooses a response or collection of responses that comprise the highest level of risk perceived by an entity being supplied products by the vendor. In certain embodiments, the response associated with highest amount of risk is selected. As another example, the aggregated response may be a superset of the responses for transaction risk assessment. As another example, the aggregated response may be a sum, difference, and/or product of one or more responses for each transaction risk assessment. At step 608, a vendor level risk assessment may be compiled. At step 610, the method determines whether a validation is required. If so, the validation is initiated at step 612. This may comprise notifying a vendor manager that a validation is required. At step 614, the method determines whether a new transaction risk assessment has been completed. If so, the method continues to step 602, where the new transaction risk assessment is retrieved.

Modifications, additions, or omissions may be made to method 600 disclosed herein without departing from the scope of the invention. The methods may include more, fewer, or other steps. Additionally, steps may be performed in parallel or in any suitable order. For example, certain embodiments of method 600 may omit steps 610 and/or 612.

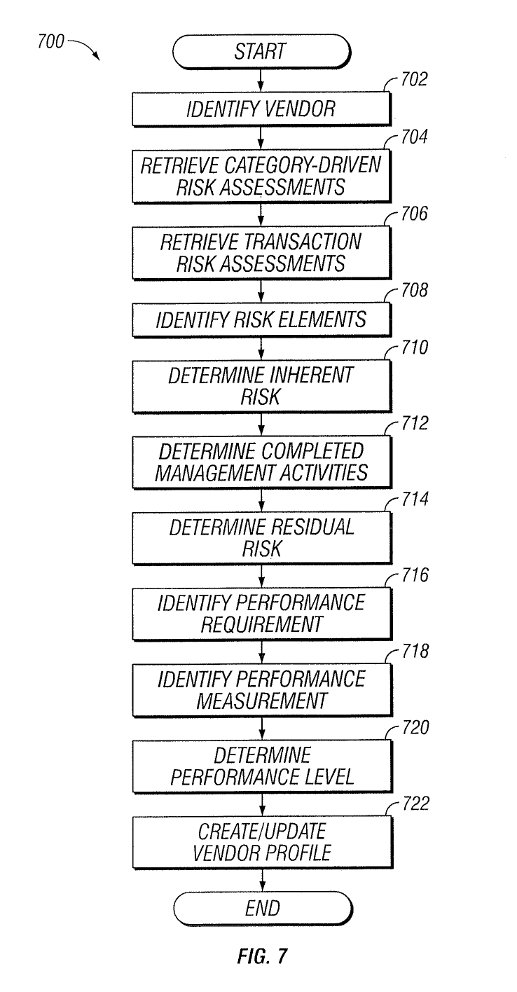

FIG. 7 illustrates an example method 700 for creating a vendor profile comprising information related to risk and performance of a particular vendor that supplies products to an entity. The method begins at step 702, where a vendor is identified. At step 704, category-driven risk assessments are retrieved for any products outsourced to the vendor. At step 706, transaction risk assessments completed for the vendor are retrieved. At step 708, risk elements discovered in any category-driven risk assessment and/or any transaction risk assessments are identified. At step 710, the method determines inherent risk associated with any identified risk elements. At step 712, the method determines whether there have been any completed management activities. At step 714, the method determines the residual risk associated with identified risk elements. This may comprise determining scores associated with inherent risk, risk reduction values associated with any management actions, and adding these values to determine residual values at the risk element level. At step 716, the method identifies any performance requirements for the vendor. At step 718, the method identifies any performance measurements. At step 720, the method determines the vendor's performance level. This may comprise comparing the performance measurements with the performance requirements. Certain embodiments may combine performance levels and risk levels to obtain an overall score for the vendor, such that a vendor with high risk for certain risk elements may have a passing score because performance levels for contract deliverables exceed expectations. The determined information may be incorporated into a vendor profile at step 722. A vendor manager may review the vendor profile and design any customized management actions for high values of residual risk and/or low performance levels. Then, the method may end, in certain embodiments.

Modifications, additions, or omissions may be made to method 700 disclosed herein without departing from the scope of the invention. The methods may include more, fewer, or other steps. For example, method 700 may include a step of presenting the vendor profile on a user interface. Additionally, steps may be performed in parallel or in any suitable order.

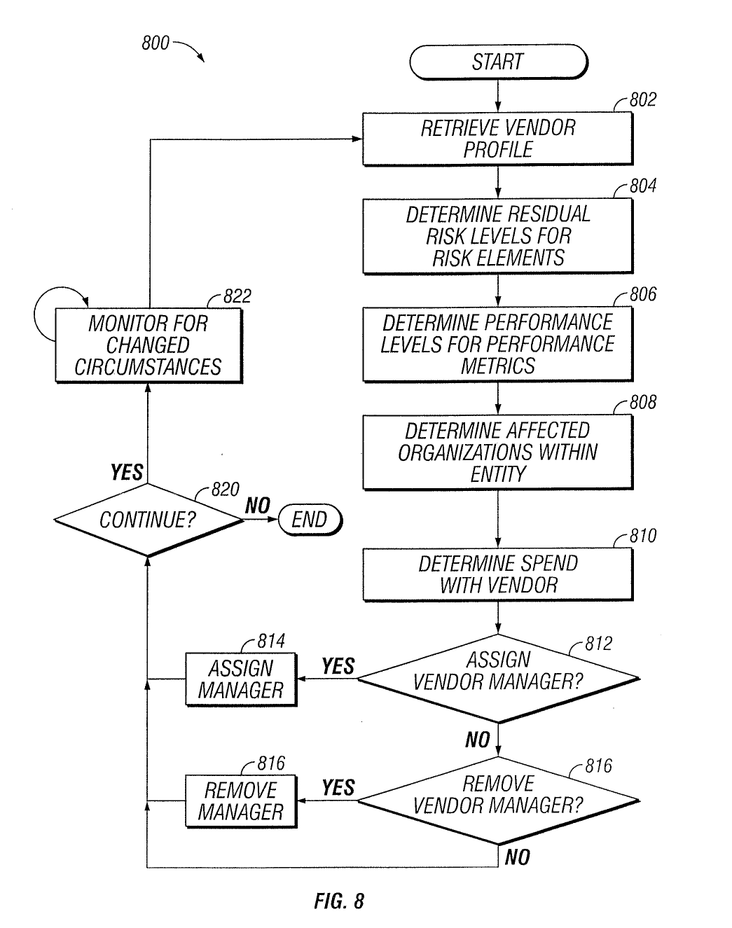

FIG. 8 illustrates an example method 800 for stratifying where in a vendor management process a vendor manager needs to be assigned. The method begins at step 802, where a vendor profile is retrieved. At step 804, the method determines residual risk levels for certain risk elements. At step 806, the method determines the performances levels associated with performance metrics of the vendor. At step 808, the method determines what organizations within the entity are affected by the vendor. If a vendor supplies products to more than one organization within an entity, that may be a factor leaning toward designation of a vendor manager. At step 810, the method determines an amount of money paid to the vendor for the products supplied to the entity. An amount of money paid to a vendor exceeding a certain threshold may be a factor leaning toward designation of a vendor manager.

At step 812, the method may determine whether a vendor manager should be assigned according to determined residual risk levels for risk elements, performance levels for performance metrics, how many organizations within the entity are supplied by the vendor, the amount of spend with the vendor, and/or by any other suitable factor. If so, the vendor is assigned at step 814. At step 816, the method determines whether to remove a vendor manager from managing a vendor. Here, the same considerations may be factored in as step 812. If so, the vendor manager is removed at step 816. At step 820, the method determines whether to continue monitoring metrics associated with the vendor. If so, the method continues to step 822, where it waits for changed circumstances in an entity's relation with the vendor. Once a change is detected, the method continues back to step 802. Back at step 820, if the method determines not to continue monitoring circumstances, the method may end.

Modifications, additions, or omissions may be made to method 800 disclosed herein without departing from the scope of the invention. The methods may include more, fewer, or other steps. For example, the method may omit step 810, such that an amount of spend is not considered when determining whether to assign a vendor manager. Additionally, steps may be performed in parallel or in any suitable order. For example, steps 806 and 808 may be performed in parallel. Additionally steps 816 may occur prior to step 812.

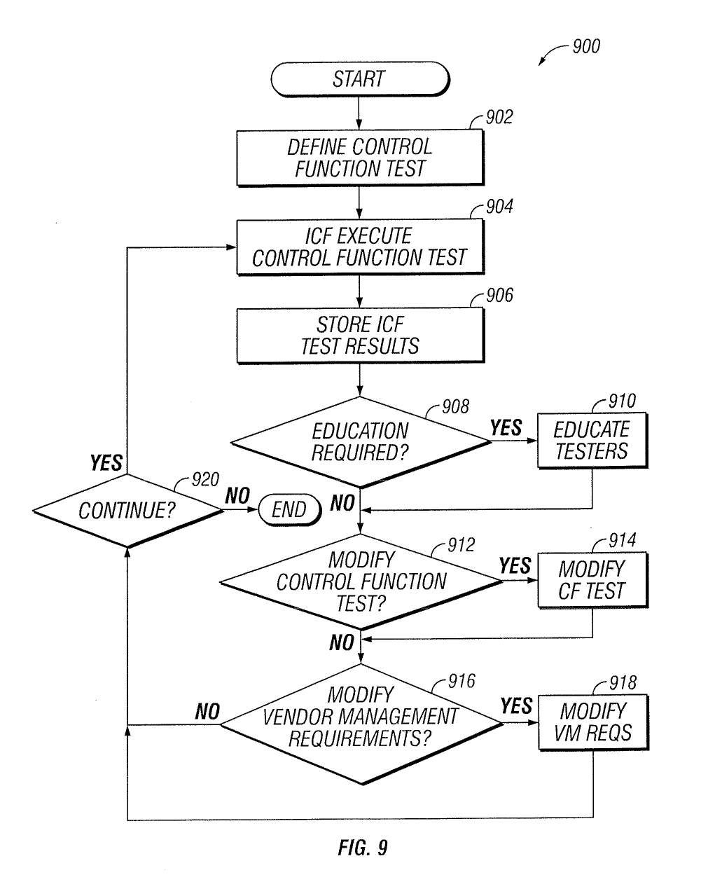

FIG. 9 illustrates an example method 900 for executing a distributed control function for overseeing execution of the vendor management process within an entity. The method begins at step 902, where a control function test is defined by an entity control function. At step 904, an internal control function executes the control function test defined by the control function test. At step 906, results of the test run by the internal control function are stored in a central repository. At step 908, the method determines whether education of a tester is required. This determination may be made based on the test results of the internal control function compared with tests executed by the entity control function. If so, internal control function testers are educated at step 910. If not, the method continues to step 912, where a determination is made as to whether the control function test itself should be modified. If so, the test is modified at step 914. If not, the method continues to step 916, where it is determined whether the vendor management requirements need to be modified. If so, the vendor management requirements are modified at step 918. If not, the method determines whether additional oversight is required at step 920. If so, the method goes back to step 904. If not, the method may end.

Modifications, additions, or omissions may be made to method 900 disclosed herein without departing from the scope of the invention. The methods may include more, fewer, or other steps. For example, step 902 defining the control function test may not be needed in certain embodiments and may be omitted. Additionally, steps may be performed in parallel or in any suitable order. For example, steps 908, 912, and 916 may be performed in parallel.

Certain embodiments of the invention may provide one or more technical advantages. A technical advantage of one embodiment allows for automatic aggregation of transaction risk assessments. Another technical advantage of an embodiment allows for automation and optimization of one or more steps in a vendor management process, reducing the overall manual workload of an assigned vendor manager. With automated aggregation processes, a vendor manager's workload may be limited to validation of an aggregation. Another technical advantage of an embodiment allows for identification of risk by automated processes at the risk element level. Management actions may be identified automatically and tailored specifically to the risk element identified rather than and/or in addition to management actions identified based on overall risk levels.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A management server, comprising:
a memory comprising rules for aggregating risk assessments associated with a vendor; and
a processor communicatively coupled to the memory and operable to:
retrieve a transaction risk assessment for a first transaction;
retrieve a transaction risk assessment for a second transaction;
determine a first response to a question for measuring risk to an entity, the first response associated with the first transaction and indicative of risk associated with engaging a vendor to supply a first product to the entity;
determine a second response to the question for measuring risk to the entity, the second response associated with the second transaction and indicative of risk associated with engaging the vendor to supply a second product to the entity;
compare the first response from the first transaction to the second response from the second transaction; and
aggregate the first response with the second response to determine an aggregated response to the question according to a highest level of risk perceived by the vendor from outsourcing the first product and the second product from the vendor.

2. The server of claim 1, wherein the processor is further operable to aggregate the first response with second response by:
selecting the first response if the first response is associated with equal or higher risk than the second response; and
selecting the second response if the first response is associated with lesser risk than the second response.

3. The server of claim 1, wherein the processor is further operable to aggregate the first response with the second response by:
creating a super set response that includes both the first response and the second response;
selecting the super set response as the aggregated response; and
determining a risk level associated with the super set response.

4. The server of claim 1, wherein the processor is further operable to aggregate the first response with the second response by:
calculating a sum of the first response and the second response; and
determining a risk level associated with the sum of the first response and the second response.

5. The server of claim 1, wherein the processor is further operable to facilitate a validation of the risk assessment aggregation determined for the vendor.

6. The server of claim 1, wherein the processor is further operable to:
automatically receive information associated with any subsequent risk assessment for any subsequent transaction associated with the vendor and the entity; and
update the risk assessment aggregation for the vendor according to results of the subsequent risk assessment.

7. The server of claim 1, wherein the processor is further operable to:
determine that the first transaction has completed; and
responsive to determining that the first transaction has completed, update the risk assessment aggregation for the vendor to exclude results of the first risk assessment for the first transaction.

8. The server of claim 1, wherein the processor is further operable to:
identify a second vendor that is associated with the vendor;
perform a third risk assessment for a third transaction with the second vendor; and
aggregate the first risk assessment and the second risk assessment for the vendor with the third risk assessment for the second vendor.

9. A method for aggregating risk assessments associated with a vendor, comprising:
retrieving a transaction risk assessment for a first transaction;
retrieving a transaction risk assessment for a second transaction;
determining a first response to a question for measuring risk to an entity, the first response associated with the first transaction and indicative of risk associated with engaging a vendor to supply a first product to the entity;
determining a second response to the question for measuring risk to the entity, the second response associated with the second transaction and indicative of risk associated with engaging the vendor to supply a second product to the entity;
comparing, using a processor, the first response from the first transaction to the second response from the second transaction; and
aggregating, using the processor, the first response with the second response to determine an aggregated response to the question according to a highest level of risk perceived by the vendor from outsourcing the first product and the second product from the vendor.

10. The method of claim 9, further comprising aggregating the first response with second response by:
selecting the first response if the first response is associated with equal or higher risk than the second response; and
selecting the second response if the first response is associated with lesser risk than the second response.

11. The method of claim 9, further comprising aggregating the first response with the second response by:
creating a super set response that includes both the first response and the second response;
selecting the super set response as the aggregated response; and
determining a risk level associated with the super set response.

12. The method of claim 9, further comprising aggregating the first response with the second response by:
calculating a sum of the first response and the second response; and
determining a risk level associated with the sum of the first response and the second response.

13. The method of claim 9, further comprising facilitating a validation of the risk assessment aggregation determined for the vendor.

14. The method of claim 9, further comprising:
automatically receiving information associated with any subsequent risk assessment for any subsequent transaction associated with the vendor and the entity; and
updating the risk assessment aggregation for the vendor according to results of the subsequent risk assessment.

15. The method of claim 9, further comprising:
determining that the first transaction has completed; and
responsive to determining that the first transaction has completed, updating the risk assessment aggregation for the vendor to exclude results of the first risk assessment for the first transaction.

16. The method of claim 9, further comprising:
identifying a second vendor that is associated with the vendor;
performing a third risk assessment for a third transaction with the second vendor; and
aggregating the first risk assessment and the second risk assessment for the vendor with the third risk assessment for the second vendor.

17. A non-transitory computer readable medium comprising logic, the logic when executed by a processor, operable to:
retrieve a transaction risk assessment for a first transaction;
retrieve a transaction risk assessment for a second transaction;
determine a first response to a question for measuring risk to an entity, the first response associated with the first transaction and indicative of risk associated with engaging a vendor to supply a first product to the entity;
determine a second response to the question for measuring risk to the entity, the second response associated with the second transaction and indicative of risk associated with engaging the vendor to supply a second product to the entity;
compare the first response from the first transaction to the second response from the second transaction; and
aggregate the first response with the second response to determine an aggregated response to the question according to a highest level of risk perceived by the vendor from outsourcing the first product and the second product from the vendor.

18. The computer readable medium of claim 17, wherein the logic is further operable to aggregate the first response with second response by:
selecting the first response if the first response is associated with equal or higher risk than the second response; and
selecting the second response if the first response is associated with lesser risk than the second response.

19. The computer readable medium of claim 17, wherein the logic is further operable to aggregate the first response with the second response by:
creating a super set response that includes both the first response and the second response;
selecting the super set response as the aggregated response; and
determining a risk level associated with the super set response.

20. The computer readable medium of claim 17, wherein the logic is further operable to aggregate the first response with the second response by:
calculating a sum of the first response and the second response; and
determining a risk level associated with the sum of the first response and the second response.

21. The computer readable medium of claim 17, wherein the logic is further operable to facilitate a validation of the risk assessment aggregation determined for the vendor.

22. The computer readable medium of claim 17, wherein the logic is further operable to:
determine that the first transaction has completed; and
responsive to determining that the first transaction has completed, update the risk assessment aggregation for the vendor to exclude results of the first risk assessment for the first transaction.

23. The computer readable medium of claim 17, wherein the logic is further operable to:
identify a second vendor that is associated with the vendor;
perform a third risk assessment for a third transaction with the second vendor; and
aggregate the first risk assessment and the second risk assessment for the vendor with the third risk assessment for the second vendor.
